(19) United States
(12) Patent Application Publication
(10) Pub. No.: US 2004/0067298 A1
(43) Pub. Date: Apr. 8, 2004

(54) Cured products of marine raw materials, and a process for the fermentation of the same

(76) Inventor: Erik Slinde, Bergen (NO)

Correspondence Address: MERCHANT & GOULD PC, P.O. BOX 2903, MINNEAPOLIS, MN, 55402-0903, US

(21) Appl. No.: 10/416,896

(22) PCT Filed: Nov. 20, 2001
(86) PCT No.: PCT/NO01/00461

(30) Foreign Application Priority Data
Nov. 20, 2000 (NO) 20005850

(51) Int. Cl. A23L 1/325

(52) U.S. Cl. 426/643

(57) ABSTRACT

A cured product from a marine raw material, and a method for fermentation of the same, are described.

The present invention relates to cured products of marine raw materials, and to a method for the fermentation of the same.

It is known that fish, and in particular fat fish such as salmon, contain large fractions of unsaturated fat. Furthermore, it is known that such unsaturated fat is nutritionally very advantageous. For that reason, fish oils have, for a long time, been given as a food supplement, and omega-3 fatty acids are today available commercially as health products. At the same time, it is noted that fish is not sufficiently utilised as a food material.

Therefore, it is an object of the present invention to provide a product in which marine raw material is utilised as the main ingredient in the manufacture of a cured product. Initially, one wishes to manufacture a cured sausage in which fat fish, in particular salmon, because of their characteristic and attractive colour as well as large amounts of unsaturated fat, is the main ingredient.

Furthermore, it is an object of the present invention that the cured sausage that is manufactured shall have a storage life corresponding to cured sausages manufactured with animal meat.

To obtain these objects, the present invention provides a method to conserve marine raw material, and in particular raw material from salmon, so that it can be used to manufacture the above-mentioned product.

The technology known from the production of cured sausage of animal meat cannot be used as fish contains large amounts of unsaturated fat. The unsaturated fat has a viscosity that is different from animal fat, and is largely subjected to hardening/rancidity.

Unsaturated fat has a lower melting point than saturated fat, and this caused considerable problems in the first test productions.

The production process comprises fermentation, smoking and curing.

As shown in the example material below, the product is fermented preferably by adding a lactic acid producing bacterium. This reduces the pH so that the stability with respect to storage and hygiene is secured.

It is known that pathogenic bacteria, such as Listeria, reduce the quality of the fish meat. Thus, it is in the fermentation process preferred to use bacteria which secrete bacteriocins that inhibits the growth of such pathogenic bacteria, and it is thus preferred that the bacteria used for the fermentation are lactic acid producing bacteria preferably strains of Lactobaccillus curvatus, Lactobaccillus sakei or Lactobacillus plantarum.

Furthermore, a cold fermentation process is preferably used, and this limits the opportunities for choice of ingredients.

The drying process reduces the amount of water so that one gets a storage stable product.

Curing is an autolytic maturation processes that takes place in raw meat which is normally salted and/or dried or smoked, and which changes the products such that they can be eaten “raw”.

For the product according to the present invention it is important that the drying of the product is sufficient for the products not to go off or rot. The enzymes in the raw material causing autolyses or partial breaking up of the material mature the product. The character of the product is changed and the raw taste and smell disappear and is replaced by smell and taste nuances, which are characteristic for cured products.

As mentioned, fat fish, and in particular salmon, contain a large amount of polyunsaturated fish fat, and this caused considerable problems during the first test productions. The fat has so low viscosity that it leaks out from the sausage during storage/drying, and it also changes the shape of the sausage in that it collects at the bottom of the sausage. This is not satisfactory and the fat must therefore be emulsified or bound.

Many aspects must be considered when selecting for an agent with an ability to bind the fat. Firstly, the fermentation process itself is a cold fermentation process that takes place at an ambient temperature, preferably below 30° C., and in particular below 22° C. Furthermore, the fat is very exposed to oxidation/rancidity because of its unsaturated state. The water and fat content in the fish meat must also be bound. Satisfactory results are achieved by using proteins as binding agent, and especially whey protein, milk protein and/or fish proteins.

The use of antioxidants prevents the material going rancid. Tests have shown that the addition of astaxanthin is beneficial as this is both a suitable colouring agent and antioxidant that functions both in the hydrophilic (water phase) and hydrophobic (fat phase) phases.

Alternatively, or in combination, antioxidants approved in foods, such as ascorbic acid or tocopherols, can be used. A preferred embodiment of the invention uses the yeast Pfaffia rhodozyma that produces astaxanthin. The yeast is allowed to grow during the fermentation process.

Alternatively, yeast protein containing astaxanthin can be added. A further alternative comprises application of astaxanthin producing algae. Further, in order to colour the products it is preferable to use the colouring agent canthaxanthine or lycopene.

Tests have shown that if a pH value below 5.5 is obtained, the product will be sufficiently stable for storage. However, it is preferred that a pH value in the range 4.5-5.0 is obtained.

To obtain a storage stable product, it is also important that the water activity in the product is below 0.93, preferably below 0.90. Drying and curing the product obtain this.

The smoke that is used can be normal smoke from wood chips; preferably wood chips from juniper, but a smoke aroma can also be used.

To obtain a storage stable product of the right consistency, colour and taste, it is important that the relative amounts of important parameters such as water activity; pH, salt, antioxidants, etc. are correctly adjusted. The amount of fat, protein and colour is therefore measured during the mixing in of raw material, and this is carried out especially with the use of NIR (near infrared spectroscopy).

### EXAMPLE 1

Test production 1 consisted of four different mixtures (products 1-4 in the table below). Product 1 is salmon with added starter culture of Lactobaccillus plantarum (Gilde), while product 2 is salmon with added starter culture of anti-Listeria, product 3 is salmon with added starter culture of Lactobaccillus plantarum (Gilde) and product 4 consists of a mixture of 50% salmon and 50% coalfish with added starter culture of Lactobacillus plantarum and a selected strain of Phaffia.

The products were subjected to a climatic programme with an incubation temperature during the first four days of 22° C. After smoking for 30 minutes, the temperature was gradually lowered to 16° C., and the products were incubated at this temperature for about 4 weeks. The air humidity (in the room) was reduced from 97 percent to 75 percent (data not shown)

Table 1 shows pH measurements after three and four weeks drying, respectively.

TABLE 1

| | | | pH, 4 weeks |
|---|---|---|---|
| Product | pH, 3 weeks | pH, 4 week | edge zone |
| 1 | 4.55 | 4.59 | 4.64 |
| 2 | 4.81 | 4.88 | 4.93 |
| 3 | 4.61 | 4.64 | 4.74 |
| 4 | 4.67 | 4.67 | 4.82 |

TABLE II
shows the water activity in the products after 5 weeks:

| Product no. | Water activity |
|---|---|
| 1 | 0.906 |
| 2 | 0.914 |
| 3 | 0.887 |
| 4 | 0.877 |

Colour and NIR Analysis of the Cured Products

Raw materials, forcemeat and finished product were analysed with NIR spectroscopy (400-2500 nm) to analyse for water, fat, protein and astaxanthin during the process and in the finished product. Product 4, which is assumed to be the leanest product (50% salmon and 50% coalfish), lies on all the plots from raw material and up to finished product on the same side of the first PC (principal component). Product 2, which contains most salmon, lies on all plots on the opposite side of the first PC. This is an indication that the fat content regulates this component.

### EXAMPLE 2

### Test Production 2

Frozen Atlantic salmon and saithe (Pollachius virens) were chopped together with salt, spices, antioxidants and a colour agent. TINE Norwegian Dairies BA produced the milk proteins added to the batters. The ground fish was stuffed into fibre casings of 70 mm diameter. Production and ripening of the batters were performed as indicated in example 1. The recipes of the produced test samples are given in Table III.

TABLE III
Recipe of the test samples. To the batters were added 3.5%
salt, 500 ppm ascorbic acid, 50 ppm tocopherol, rosmarin,
salvie, colour and starter culture.

| Production | | | |
|---|---|---|---|
| no. | Salmon % | Saithe % | Additive |
| 1 | — | 100 | |
| 2 | 34 | 66 | |
| 3 | 50 | 50 | |
| 4 | 50 | 50 | 2% of milk |
| | | | protein |
| 5 | 50 | 50 | 5% of milk |
| | | | protein |
| 6 | 50 | 50 | 1% of milk |
| | | | protein |
| 7 | 66 | 34 | |
| 8 | 100 | — | |
| 9 | 50 | 50 | 2% of Cream powder |
| 10 | 50 | 50 | 2% of Sodium |
| | | | caseinate |
| 11 | 50 | 50 | 2% of Rennet |
| | | | casein |

The lactobacilli used as starter cultures were strain V-L (Nordal and Slinde, 1980) and ALC 01 (anti Listeria) was from Danisco, Denmark. The bacteria were cultured overnight (18-20 hours) in MRS broth at 30° C., centrifuged and dissolved in 0.9% NaCl. Approximately 2×10⁶ bacteria pr gram batter were added. Growth of bacteria, water activity (a_{w}) and pH were measured during the ripening process (Skjelkv\dot{a}le et al., 1974; Slinde 1987).

Near-Infrared Reflectance Spectroscopy

Reflectance was measured in a single-beam scanning monochromator instrument (NIRSystems 6500, NIRSystems Inc., Silver Spring, MD, USA). The wavelength range was 1100-2500 nm in 2 nm steps. The calibration of the instrument was carried out using minces of salmon with different fat, water and protein content. The cross-validated prediction error for the fat calibration was 0.72%, for water 0.66%, and for protein 0.34%.

Ground salmon mince was filled into polyethylene bags (NIRSystems no NR-7060) and placed in a 10 mm “high-fat, high-moisture” sample cell (NIRSystems no NR-7042). The samples were measured at 2-4° C. in the NIR instrument with an elevator sample system (NIRSystems no 6523) connected. Each reflectance measurement was an average of 32 scans.

Determination of Fat, Protein and Water:

The fish minces were ground in a mill (Electrolux, model N10, Sweden) with 2 mm hole diameter (0-4° C.), and analysed in duplicates for fat (Fosslet, Foss Electric, Hillerød, Denmark), moisture (105° C. at 18 h) and protein (Kjeltec Auto 1030, Tecator AB, Höganäs, Sweden). The averages for fat, moisture and protein for each sample were calculated and used in the subsequent calculations.

Texture Analysis Warner-Bratzler shear force measurements were performed using an Instron Materials Testing Machine (Model 4202, Instron Engineering Corporation, High Wycombe, UK) equipped with WB shear-press device. The samples were sliced into pieces of 1×1 cm for thickness; the length of each sample was 2 cm. The maximum shear force for ten parallels was recorded per sausage and the average of the readings was used in the data analysis.

Regression and Explorative Data Analysis:

All calculations were performed by full cross validation. The Unscrambler (version 7.5, Camo, Norway), performed the Principal component analysis (PCA) and PLS1 computations (Martens and Næs, 1993).

### Results

Fermentation. After smoking and ripening for approximately 20 days the water activity was below or equal to 0.9 and the pH were approximately 5.0 in the different samples.

Spectroscopic Measurement of Fat, Protein and Water.

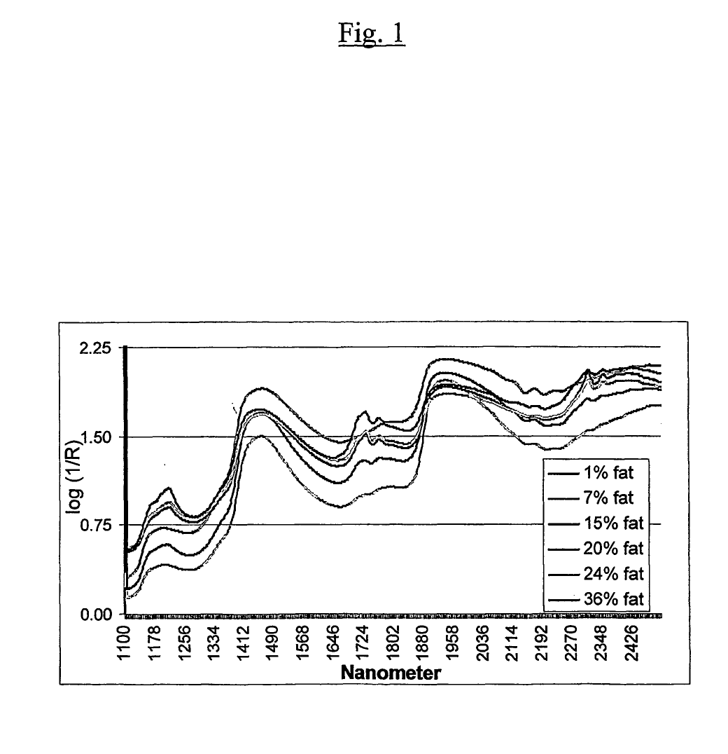

NIR (FIG. 1) is a rapid and accurate method for a wide range of analytical applications and are used on-line as an alternative to wet chemistry in the quality control of food products. NIR spectroscopy offers many advantages for quantitative analysis since it is fast with no or minimal sample preparation. The precision is high and there is no need for chemicals. Once calibration is done the instrument is simple to operate, and the calibration is generally stable within the calibration range.

Data Analysis

Regression was performed by the principal least square (PLS1) method. PLS1 are also a linear modelling method, but projects a spectrum on to PLS factors. PLS1 extracts the spectral information with the largest covariance to the dependent variable. In the calibration model a small number of these factors relate the independent variables (wavelengths) to the dependent variable. PLS1 was performed with the amount of fat as dependent variables to examine the influence of these values on the spectra. All predictions were performed with full cross validation. Compression of the data were performed by principal component analysis (PCA) (Martens and Næs 1993). PCA is a linear modelling method, which handles the colinearity problem. The method projects the spectra onto principal components (PCs), which represent the main variation in the data set. PC scores are the projected locations of the samples onto each PC. They indicate which factors that are responsible for most of the variation. The loadings express the spectral variation that corresponds to each PC.

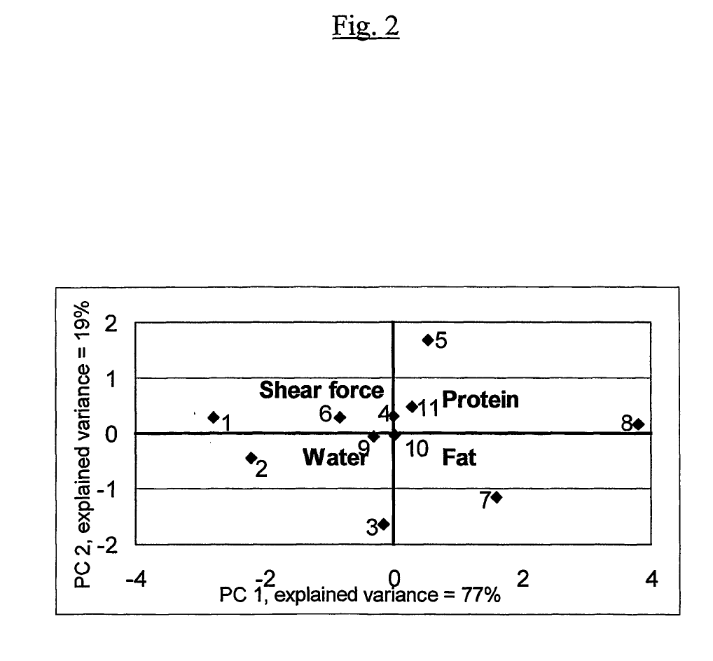

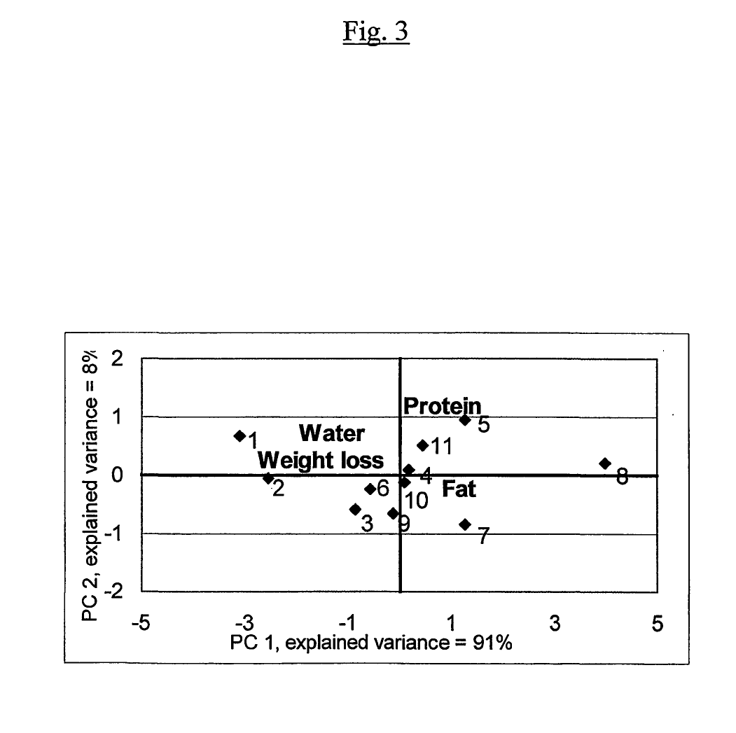

FIG. 2 shows the PCA bi-plot of the samples with regard to protein, fat, water and shear force. The x-axis distributes the samples mainly between low and high fat, i.e. from saithe with 1.5% fat to salmon with 14.3% fat content (Table IV). The y-axis distributes the samples from low to high content of protein, but a combination between fat and protein also exist. The effect of added protein has its main effect on the shear force where it is seen that the addition of 5% milk protein increases the shear force to 15.1×10⁻¹ kg/cm² (Table 2). When texture is included in the PCA plot one see that the y-axis distributes the samples mainly according to their shear force. The moisture loss shows that the dry matter content is the main factor that distributes the samples along the x-axis (FIG. 3).

FIG. 1. NIR spectra of salmon and saithe with different fat content. The correlation coefficient between measured and predicted samples was 0.998

FIG. 2. PCA bi-plot of the test samples when protein, fat, water and shear force are included. Explained variance by PC1 was 79% and for PC2 19%.

FIG. 3. PCA bi-plot of the test samples when protein, fat, water and weight loss are included. Explained variance by PC1 was 91% and for PC2 8%.

TABLE IV
Determined amount (predicted) fat, water and protein by
NIR in the test samples. The Warner-Bratzler shear force
was measured as kg × 10⁻¹/cm².

| Sample | | | | Shear |
|---|---|---|---|---|
| no. | % Water | % Fat | % Protein | force |
| 1 | 76.3 | 1.5 | 17.2 | 15.6 |
| 2 | 74.0 | 3.0 | 17.1 | 13.4 |
| 3 | 70.9 | 7.6 | 17.6 | 7.0 |
| 4 | 68.8 | 8.1 | 18.8 | 12.7 |
| 5 | 66.6 | 8.2 | 17.8 | 15.1 |
| 6 | 69.9 | 7.0 | 17.4 | 14.3 |
| 7 | 65.3 | 11.7 | 17.3 | 6.6 |
| 8 | 59.2 | 14.3 | 20.2 | 6.0 |
| 9 | 67.5 | 8.2 | 17.1 | 13.2 |
| 10 | 68.7 | 8.1 | 17.8 | 11.7 |
| 11 | 68.5 | 7.8 | 18.7 | 12.0 |

1. Method for manufacture of a cured product, characterised in that the method comprises the steps:
that raw material, in which the main component is marine raw material, is ground and mixed to a forcemeat,
that the forcemeat is fermented,
and that the forcemeat is dried and cured until a storage stable product is obtained.

2. Method in accordance with claim 1, characterised in that the fermentation is a cold fermentation.

3. Method in accordance with claim 1, characterised in that a lactic acid producing bacterium is used in the fermentation process.

4. Method in accordance with claim 3, characterised in that the lactic acid producing bacterium is selected from the group comprising Streptococcus, Leuconostoc, Pediococcus and Lactobacillus.

5. Method in accordance with claim 4, characterised in that the Lactobacillus is selected from the group comprising Lactobaccillus plantarum, Lactobaccillus curvatus and Lactobaccillus sakei.

6. Method in accordance with claim 1, characterised in that the fermentation process lowers the pH value of the material to below 5.5.

7. Method in accordance with claim 6, characterised in that the pH value is in the range 4.5-5.0.

8. Method in accordance with one of the claims 1-6, characterised in that the marine raw material in the main comprises salmon, or other fish rich or not so rich (even lean?) in unsaturated fat.

9. Method in accordance with one of the claims 1-8, characterised in that fat with a lower melting point is immobilised in the forcemeat by the use of a binding agent.

10. Method in accordance with claim 9, characterised in that the binding agent is a protein.

11. Method in accordance with claim 10, characterised in that the protein is selected from the group comprising whey protein, milk protein, fish protein and/or soy protein.

12. Method in accordance with one of the claims 1-11, characterised in that an anti-oxidising agent is added to the forcemeat.

13. Method in accordance with claim 12, characterised in that the anti-oxidising agent is astaxanthin.

14. Method in accordance with one of the claims 1-13, characterised in that a colouring agent, or a micro-organism which can produce a colouring agent under the prevailing conditions, is added to the forcemeat.

15. Method in accordance with claim 14, characterised in that the colouring agent is lycopene, canthaxanthine and/or astaxanthin.

16. Method in accordance with claims 14 and 15, characterised in that the micro-organism is Phaffia rhodozyma.

17. Method in accordance with claims 14 and 15, characterised in that the micro-organism is the algae Haematococcus pluvialis.

18. Method in accordance with one of the claims 1-17, characterised in that the water activity of the forcemeat during drying is reduced to below 0.93, preferably to 0.90 or lower.

19. Method in accordance with one of the claims 1-18, characterised in that the product is smoked.

20. Cured product, characterised in that it comprises marine raw material as a main component.

21. Cured product in accordance with claim 20, characterised in that the marine raw material in the main comprises salmon, or other fish rich/or not so rich even lean? in unsaturated fat.

22. Cured product in accordance with claim 20, characterised in that the product is storage stable.

23. Cured product in accordance with claim 20, characterised in that colour is added to the product.

24. Cured product in accordance with claim 23, characterised in that the colour is astaxanthin.

25. Cured product in accordance with claim 24, characterised in that astaxanthin is added as a chemical compound, and/or in that to the fermentation process is added microorganisms such as Pfaffia rhodozyma or the algae Haematococcus pluvialis which during the process produces astaxanthin, or that the astaxanthin is added as dried Pfaffia rhodozyma.

26. Cured product in accordance with claim 20, characterised in that aromatic compounds are added to give the product a taste of salami.
